(19) United States
(12) Patent Application Publication
(10) Pub. No.: US 2024/0007375 A1
(43) Pub. Date: Jan. 4, 2024

(54) LOCATION-BASED PROXY FOR VIRTUAL MEETING OPTIMIZATION

(71) Applicant: Citrix Systems, Inc., Ft. Lauderdale, FL (US)

(72) Inventors: JUNJIE JIN, Nanjing (CN); HAIYANG XU, Nanjing (CN); JIGAO HUANG, Nanjing (CN)

(73) Assignee: Citrix Systems, Inc., Ft. Lauderdale, FL (US)

(21) Appl. No.: 17/814,925

(22) Filed: Jul. 26, 2022

Related U.S. Application Data
(63) Continuation of application No. PCT/CN2022/102850, filed on Jun. 30, 2022.

(51) Int. Cl. H04L 43/0852; H04L 43/50; H04L 67/56; H04L 65/1069; H04L 65/403; H04L 61/2589

(52) U.S. Cl. CPC H04L 43/0852; H04L 43/50; H04L 67/56; H04L 65/1069; H04L 65/403; H04L 61/2589

(57) ABSTRACT

Methods and apparatus for improving performance in a virtual meeting session in a distributed workspace system. One example of such a method includes acts of launching the virtual meeting session on a computing device of a first meeting participant, establishing a first connection between the computing device and a virtual meeting server, monitoring network latency conditions in the first network connection, upon determining that the network latency conditions exceed a predetermined threshold, selecting a proxy agent and establishing a second network connection between the computing device and the proxy agent, and establishing a third network connection between the virtual meeting server and the proxy agent to connect the computing device to the virtual meeting server through the proxy agent.

### RELATED APPLICATION

This application claims priority under 35 U.S.C. § 120 as a continuation of PCT Application No. PCT/CN2022/102850, entitled “LOCATION-BASED PROXY FOR VIRTUAL MEETING OPTIMIZATION” and filed Jun. 30, 2022 which is hereby incorporated herein by reference in its entirety.

### BACKGROUND

Virtual collaboration products are computer-implemented tools that facilitate online sharing and exchange of audio, video, and other types of data between users. One of the most common types of virtual collaboration is a virtual meeting, where multiple attendees, or participants, can communicate with each other in real-time through an audio/video conference even when the participants are not physically situated in the same location.

### SUMMARY

Aspects and embodiments are directed to methods and apparatus for improving virtual meeting experiences, and in particular, to monitoring network latency and dynamically employing one or more proxy agents to improve latency conditions, when necessary, and thereby provide enhanced video and/or audio performance for meeting participants.

According to one embodiment, a method of improving performance in a virtual meeting session in a distributed workspace system comprises launching the virtual meeting session on a computing device of a first meeting participant, establishing a first connection between the computing device and a virtual meeting server, monitoring network latency conditions in the first network connection, upon determining that the network latency conditions exceed a predetermined threshold, selecting a proxy agent and establishing a second network connection between the computing device and the proxy agent, and establishing a third network connection between the virtual meeting server and the proxy agent to connect the computing device to the virtual meeting server through the proxy agent.

Various embodiments of the method may include one or more of the following features.

In one example, monitoring latency conditions in the first network connection comprises requesting information regarding the latency conditions from the virtual meeting server via an application programming interface.

In another example, wherein monitoring latency conditions in the first network connection includes transmitting a test message from the computing device over the first network, and monitoring a return time of the test message to the computing device.

In one example, the virtual meeting server is a traversal using relay network address translation (TURN) server selected based on a geographic location of a second meeting participant in the virtual meeting session, and selecting the proxy agent includes selecting the proxy agent based on a geographic location of the first meeting participant, the first and second geographic locations being different.

In one example, monitoring the network latency conditions is performed during the launching of the virtual meeting session on the computing device.

In another example, monitoring the network latency conditions is performed periodically during the virtual meeting session.

In one example, launching the virtual meeting session includes accessing a virtual machine through a digital workspace application running on the computing device, the virtual machine hosting a virtual meeting application configured to connect the first meeting participant to the virtual meeting session.

Certain embodiments are directed to computer systems configured to implement examples of the methods including any of the features discussed herein.

According to one embodiment, a computer system comprises a memory storing a plurality of instructions, at least one network interface, and at least one processor coupled to the memory and to the at least one network interface and configured execute the plurality of instructions to: launch a virtual meeting session and establish a first network connection to a virtual meeting server via the at least one network interface; monitor latency conditions in the first network connection; upon determination that the latency conditions exceed a predetermined threshold, select a proxy agent and establish a second network connection to the proxy agent; and reestablish connection to the virtual meeting server via the proxy agent.

Various embodiments of the computer system may include any one or more of the following features.

In one example, to monitor the latency conditions, the at least one processor is configured to request information regarding the latency conditions from the virtual meeting server via an application programming interface.

In another example, to monitor the latency conditions, the at least one processor is configured to transmit a test message over the first network, and monitor a return time of the test message.

In one example, the processor is configured to monitor the latency conditions during launch of the virtual meeting session.

In another example, the processor is configured to monitor the latency conditions periodically during the virtual meeting session.

In another example, the processor is configured to select the proxy agent based on a geographic location of the computer system.

According to another embodiments, a method of improving performance in a virtual meeting session in a distributed workspace system comprises providing a digital workspace application on an endpoint computing device, providing access through the digital workspace application, to a virtual meeting application, launching the virtual meeting session using the virtual meeting application accessed through the digital workspace application, establishing a first network connection from the computing device to a virtual meeting server, with the digital workspace application, monitoring network latency conditions in the first network connection, upon determining that the network latency conditions exceed a predetermined threshold, selecting a proxy agent and establishing a second network connection from the computing device to the proxy agent, and connecting to the virtual meeting server through the proxy agent to provide access to the virtual meeting session.

Various embodiments of the method may include any one or more of the following features.

In one example, monitoring latency conditions in the first network connection comprises requesting information regarding the latency conditions from the virtual meeting server via an application programming interface.

In another example, monitoring latency conditions in the first network connection includes transmitting a test message from the computing device over the first network, and monitoring a return time of the test message to the computing device.

In one example, the virtual meeting server is a traversal using relay network address translation (TURN) server selected based on a geographic location of a first meeting participant in the virtual meeting session, and selecting the proxy agent includes selecting the proxy agent based on a geographic location of the endpoint computing device, the first and second geographic locations being different.

In one example, monitoring the network latency conditions is performed during the launching of the virtual meeting session using the virtual meeting application accessed through the digital workspace application.

In another example, monitoring the network latency conditions is performed periodically during the virtual meeting session.

In another example, selecting the proxy agent includes selecting the proxy agent to provide the second network connection having lower network latency conditions than the first network connection.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this disclosure. However, the figures are not intended as a definition of the limits of any particular example. The figures, together with the remainder of this disclosure, serve to explain principles and operations of the described and claimed aspects. In the figures, each identical or nearly identical component that is illustrated is represented by a like reference numeral. For purposes of clarity, every component may not be labeled in every figure. In the figures:

FIG. 1 is a logical block diagram of one example of a distributed workspace system according to various aspects disclosed herein;

FIG. 2 is a logical block diagram of one example of an implementation of a virtual meeting application in a distributed workspace system according to various aspects disclosed herein;

FIG. 3 is a diagram illustrating one example of a geographic set-up for a virtual meeting session;

FIG. 4 is a diagram illustrating one example of an arrangement for improved virtual meeting performance according to various aspects disclosed herein;

FIG. 5 is a flow diagram of one example of a method of improving virtual meeting performance according to various aspects disclosed herein; and

FIG. 6 is a logical block diagram of a computing device configured to implement various systems and processes in accordance with examples disclosed herein.

### DETAILED DESCRIPTION

Virtual collaboration products, and particularly virtual meeting applications, are widely used, often to connect people in very distant geographic locations. For example, virtual meetings can have participants who are physically located in different cities, different states/provinces, or even different countries. Generally, a cloud-based server is used to establish and control the network connections between the computing devices on which each participant is running their virtual meeting application. Although various software tools and protocols are designed to support communication channels providing high quality audio and video for virtual meetings, there are still circumstances in which one or more participants experience degraded communication performance, such as delays in the audio and/or video, or poor sound and/or picture quality. For example, cross-geographic meeting performance can still sometimes be poor, or at least sub-optimal, particularly where several meeting participants are in one general geographic location (e.g., all in the same urban area or same country) and one or more other participants are in another, distant geographic location (e.g., a different country). In certain instances, the distant participant(s) can experience poor audio and/or video performance due to high network latency in the connection between the server handling the virtual meeting session and the distant participant(s).

Accordingly, aspects and embodiments are directed to systems and methods for improving cross-geographic meeting performance by monitoring network latency and altering the selection of server handling the virtual meeting session to improve latency conditions when necessary. As discussed further below, aspects and embodiments provide for the dynamic selection of a location-based proxy agent to improve network latency conditions in the network connection to one or more participants and thereby improve the virtual meeting performance.

For example, according to one embodiment, a computer system may comprise a memory storing a plurality of instructions, at least one network interface, and at least one processor coupled to the memory and to the at least one network interface. The at least one processor can be configured to execute the plurality of instructions such that the computer system can launch a virtual meeting session and establish a first network connection to a virtual meeting server via the at least one network interface, monitor latency conditions in the first network connection, upon determination that the latency conditions exceed a predetermined threshold, select a proxy agent and establish a second network to the proxy agent, and reestablish connection to the virtual meeting server via the proxy agent.

Sample Computing Systems

In some examples, a distributed system is configured to implement workspace and system access to remote users, thereby providing a central repository of applications, files, and other similar resources to a group of trusted users accessible via, for example, an enterprise service. A distributed workspace can be implemented as a software platform designed to deliver and manage a user's applications, data, and desktops in a consistent and secure manner, regardless of the user's device or location. A distributed workspace allows users to access functionality provided by multiple enterprise applications, including, for example, software as a system (SaaS) applications, web applications, desktop applications, and proprietary applications, through a single interface.

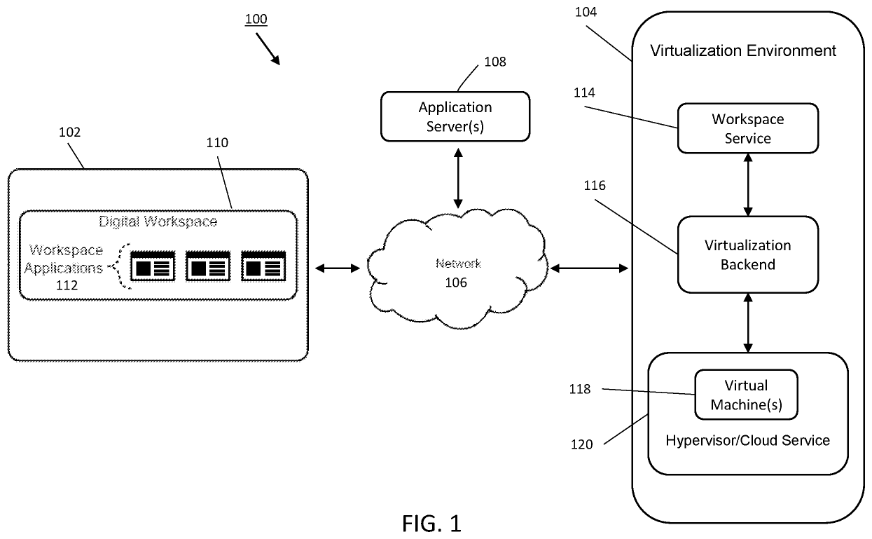

FIG. 1 illustrates a logical architecture of one implementation of, for example, a distributed workspace system 100 that is configured to connect one or more endpoint computing devices 102 with one or more remote computing devices configured to host shared resources such as applications accessible via the distributed workspace. As shown in FIG. 1, the system 100 can include an endpoint device 102 that may be operably connected to a remote computing system, referred to herein as a workspace or virtualization environment 104, via one or more networks 106. The virtualization environment 104 may comprise one or more of a variety of suitable computing devices, such as a desktop computer, a laptop computer, a workstation, an enterprise-class server computer, a tablet computer, or any other device capable of supporting the functionalities disclosed herein. A combination of different devices may be used in certain examples. The endpoint device 102 be a computing device that is used by the user. Examples of such a computing device include but are not limited to, a desktop computer, a laptop computer, a tablet computer, and a smartphone. A user's association with the endpoint device 102 may exist by virtue of, for example, the user being logged into or authenticated to the endpoint device 102. The virtualization environment 104, the endpoint device 102, and one or more application servers 108 communicate with each other via the network 106.

The network 106 may be a public network (such as the Internet) or a private network (such as a corporate intranet or other network with restricted access). The network 106 can be a wired network, a wireless network, or a combination of both wired and wireless networks. In certain examples, the network 106 can include any type of network, including a local area network (LAN), a wide area network WAN), such as the Internet or an intranet as noted above, a metropolitan area network (MAN), a primary public network, or a primary private network.

The endpoint device 102 is configured to execute a virtual desktop application, also referred to as a digital workspace app 110. The digital workspace app 110 can be configured to provide an interface to allow remote access to one or more resources hosted at or by, for example, the virtualization environment 104. In certain examples, the user interacts with a plurality of workspace applications 112 that are accessible through the digital workspace app 110, which can serve as a workspace client application, for example executing as part of a virtualization infrastructure, as discussed further below. The workspace applications 112 can include any of a wide variety of applications, including, but not limited to, a scheduling application, a task assignment/management application, a billing application, a word processing application, a spreadsheet application, a coding application, a chat application, an email client application, a calendar application, a conferencing application, a file management application, a virtual meeting application, and other similar applications that a user may interact with during a distributed workspace session. In certain examples, the workspace applications 112 can be hosted by the application servers 108 and/or can be provided locally at the endpoint device 102.

According to certain examples, the virtualization environment 104 includes a workspace service 114 that acts as a front-end for various back-end services 116 that can execute, operate, or otherwise provide various applications and services to enable and support the digital workspace app 110 and the workspace applications 112 provided therein, including any of: web-based client services; a client-server application; a thin-client computing client; an ActiveX control; a Java applet; software related to voice over internet protocol (VoIP) communications like a soft Internet Protocol telephone; an application for streaming video and/or audio; an application for facilitating real-time-data communications; a HyperText Transfer Protocol (HTTP) client; a File Transfer Protocol (FTP) client; an Oscar client; a Telnet client; or any other set of executable instructions. In some examples, the virtualization environment 104 can be configured to execute one or more virtual machines 118 providing access to a computing environment to a user of endpoint device 102. The virtual machine(s) 118 can be managed by, for example, a hypervisor 120, or any other hardware virtualization technique. In some examples, the workspace server 104 can execute a remote presentation services program or other program that uses a thin client or a remote-display protocol to capture display output generated by an application executing on the virtualization environment 104 and transmit the application display output to the endpoint device 102 for presentation to one or more device users.

In some examples, the workspace service 114 is configured to implement and coordinate with the digital workspace app 110 and to provide the workspace applications 112 to the user of the endpoint device 102 through the digital workspace app 110. In certain examples, the digital workspace app 110 can be configured to allow a user of the endpoint device 102 to access a virtual machine 118 hosted in the virtualization environment 104. The virtualization backend system 112 may include one or more servers, gateways, and/or services as part of a virtualization infrastructure. For example, the workspace applications 112 can be implemented within a variety of computing resources including a virtualization infrastructure (e.g., a virtual machine 118), such as the High-Definition User Experience (HDX) virtualization infrastructure commercially available from Citrix Systems of Fort Lauderdale, Fla. The digital workspace app 110 can be implemented using, for example, the Citrix Workspace™ application, a browser embedded within the digital workspace application, a secure browser service, such as the Citrix Secure Browser™ service, and/or other computing resources. In certain examples, the workspace service 114, the backend system 116, and the digital workspace app 110 together provide the infrastructure and services for a user of the endpoint device 102 to access and interact with the workspace applications 112, which in certain examples may be accessed using the (HDX)/ICA remoting protocol.

Virtual Meeting Optimization

As discussed above, in certain examples, at least one of the workspace applications 112 executing in the digital workspace app 110 on the endpoint device 102 can be configured to provide a virtual collaboration or meeting environment. For example, a workspace application 112 may support one or more sessions for any virtual meeting platform such as GoToMeeting®, Skype®, Slack®, Google Hangouts®, Zoom®, Microsoft Teams®, Google® Meeting, Cisco WebEx®, or other computer software configured to create, host, and deliver online conferences, meetings, demonstrations, tours, presentations, and discussions among multiple participants, including organizers and attendees.

In certain examples, a virtual meeting session, such as a desktop-based Microsoft Teams® session, can be implemented in a distributed workspace environment, such as the distributed workspace system 100 discussed above, using the digital workspace app 110 and the virtualization environment 104. In certain examples, a virtual meeting application can be accessed via a virtual machine 118 that can be presented to a user of an endpoint device 102 through the digital workspace app 110 as discussed above. In such examples, all the necessary components can be bundled into the digital workspace app 110 and the virtual machine 118.

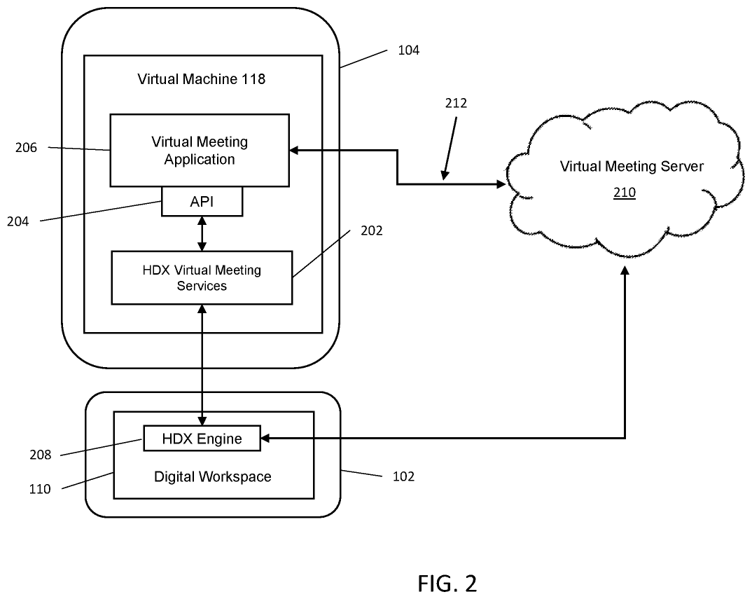

Referring to FIG. 2, there is illustrated a logical architecture of one implementation of components for operating a virtual meeting application, such as, but not limited to Microsoft Teams®, in a distributed workspace system, such as the system 100 discussed above. In this example, a virtual meeting session can be optimized using HDX services 202 implemented in the virtual machine 118 with an application programming interface (API) 204 to interface with a hosted virtual meeting application 206 to receive commands. A corresponding HDX engine 208 within the digital workspace app 110 can coordinate with the HDX services 202 in the virtual machine 118 to control, and attempt to optimize, the audio and video performance of the virtual meeting. As discussed above, a user of the endpoint device 102 can access the virtual meeting application 206 via the digital workspace app 110. The virtual machine 118 and the HDX engine 208 communicate with a virtual meeting server 210 (e.g., one of the application servers 108 discussed above) via a network connection 212 to exchange data and perform various functions to operate the virtual meeting, such as: authentication to allow the user to access the virtual meeting session; signaling (e.g., indicating that a user has joined the virtual meeting); enabling messaging within the virtual meeting session; and allowing for audio and/or video media exchange and screensharing among participants in the virtual meeting. In certain examples, the hosted virtual meeting application 206 is an agent or client application that is executed on the virtual machine 118 and presented to a user of the endpoint device through the digital workspace app 110, as discussed above, and communicates with a virtual meeting service that is hosted by the virtual meeting server 210 (such as a Microsoft Azure server, for example).

According to various examples, for a virtual meeting application 206 hosted within the virtual environment and provided via the digital workspace app 110, real-time communication (RTC), particularly WebRTC in certain examples, can be implemented by the HDX services 202 and HDX engine 208 to optimize the audio and/or video performance. In computing environments, RTC is a collection of software protocols and hardware designed to provide responses to communication events within a guaranteed time constraint, often on the order of several milliseconds or less. RTC is useful for efficient messaging frameworks, such as text messaging, telephony, live video conferencing, screen sharing, control and monitoring of remote devices, location-based services, medical patient monitoring, and other applications requiring low latency communications. There are several existing RTC protocols. For example, WebRTC is a protocol that provides web browsers and mobile applications with RTC via APIs. WebRTC enables direct, peer-to-peer communication, which limits or eliminates delays that are potentially introduced by intermediary software and hardware. WebRTC applications can create bi-directional audio, video, and data connections over ephemeral User Datagram Protocol (UDP) ports between two WebRTC-capable devices, such as between two web browsers on a computer or smartphone, or between two dedicated WebRTC appliances (e.g., various thin clients such as voice-over-internet phones or Internet of Things (IoT) devices), or between the computer and a dedicated appliance. WebRTC can use peer-to-peer UDP connections to traverse the network for communication directly between peer devices. However, in some cases these peer-to-peer communications are relayed through intermediary services due to restrictions imposed by network firewalls or other products, and in some other cases the peers do not reside in the public Internet but rather in private address spaces behind Network Address Translators (NATs). When endpoint device 102 is behind a NAT, other endpoint devices rely on a relay to traverse the NAT. For example, WebRTC applications running in a web browser can utilize a list of Traversal Using Relays around NAT (TURN) servers that assist in the traversal of NATs or firewalls. The TURN server relays traffic from one peer to another, after the TURN server receives a request from the WebRTC client to relay that traffic. Thus, a TURN server can extend a UDP socket from the WebRTC client device to the TURN server.

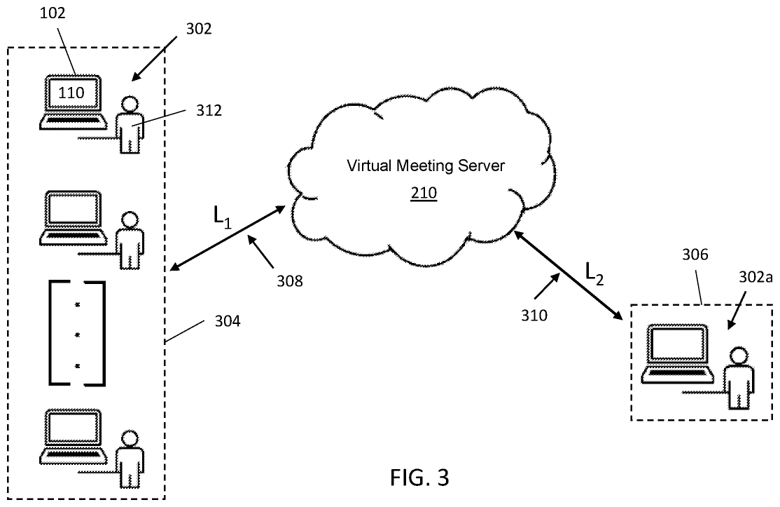

However, even using tools such as WebRTC and HDX protocols, there are circumstances in which one or more participants may experience poor audio and/or video quality during a virtual meeting session. For example, as discussed above, when one meeting participant is located geographically distant from other participants, high network latency in the connection to the distant participant can degrade performance. FIG. 3 illustrates an example of this scenario. As shown in FIG. 3, a group of one or more participants 302 in a virtual meeting may all be located in the same or a similar geographic location, as represented by dashed-line boundary 304 (referred to as region 304). Another participant 302a may be located in a distant geographic location (region 306), far away from the other participants 302. For example, region 304 may be one country, while region 306 may be another country, potentially very distant from region 304. Each of the participants 302, 302a may include a user 312 who accesses the virtual meeting session via a virtual meeting application 206 executing in a virtual environment and accessed via a digital workspace app 110 running on an endpoint device 102, as discussed above with reference to FIGS. 1 and 2.

Referring to FIGS. 2 and 3, when a virtual meeting session is initiated, the virtual meeting application 206 selects and connects to a virtual meeting server 210. The virtual meeting application 206 may go through any necessary authentication procedures and establish necessary communications policies and signaling channel setup. In certain instances, the virtual meeting application 206 may detect that it is operating within the virtual machine 118, and make calls to the API 204 to establish connections and communications with the HDX meeting services 202 and the HDX engine 208. Through the virtual meeting server 210, end-to-end signaling paths can be established between the participants 302 (including participant 302a). In certain examples, the virtual meeting application 206 executing on the endpoint device 102 corresponding to the virtual meeting host asks the HDX engine 208 for a series of supported call parameters (codecs, resolutions, and so forth, which is known as a Session Description Protocol (SDP) offer). These call parameters are then relayed to the other participants using signaling paths via the virtual meeting server 210 to establish secure connections and media channels among the various participants 302, 302a.

Still referring to FIGS. 2 and 3, in the circumstance illustrated in FIG. 3, the virtual meeting application 206 may generally select a virtual meeting server 210, which in the case of the virtual meeting application being Microsoft Teams® may be a Microsoft Azure TURN server, for example, based on the relatively close proximity of the group of participants 302. As discussed above, the virtual machine 118 may have access to a list of available TURN (or other) virtual meeting servers. As part of the virtual meeting initialization one of those available virtual meeting servers can be selected. For example, when the virtual meeting application 206 corresponding to the host participant who is a participant 302 in the region 304 completes the signally negotiations and meeting set-up procedures with the virtual meeting server 210, the result may be selection of a virtual meeting server 210 that is geographically located within or close to the region 306. Accordingly, the connections 308 between the participants 302 in region 304 and the virtual meeting server 210 may have low latency conditions (representative latency L₁ in FIG. 3), and the participants 302 may accordingly, experience good audio and/or video performance for their virtual meeting session. On the other hand, the participant 302a who is located geographically distant from the region 304 and now therefore distant from the selected virtual meeting server 210, may have a network connection 310 to the virtual meeting server 210 that has high latency conditions (latency L₂ in FIG. 3) and as a result may experience poor audio and/or video performance.

Although in some instances the virtual meeting application 206 may attempt to optimize the selected virtual meeting server 210 to balance the geographic locations of all participants 302, 302a, the result is still selection of a single virtual meeting server 210 which is made without monitoring latency conditions L₁ and L₂. In the scenario of FIG. 3, the selection of the virtual meeting server 210 may still be biased towards the larger group of participants 302 in region 304, which may leave participant 302a with poor performance. Further, attempts to balance the location of region 306 with region 304 may in fact result in reduced meeting quality for all participants 302, while not providing participant 302a with much (or any) improvement.

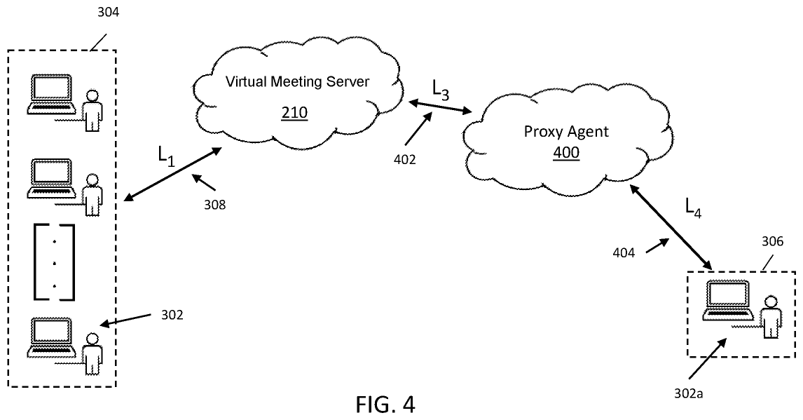

Accordingly, aspects and embodiments provide a solution that involves the dynamic selection and addition of a proxy agent to improve the latency conditions in the network connection between the participant 302a and the virtual meeting server 210, while maintaining the optimized selection of the virtual meeting server 210 and negotiated communications therewith based on the participants 302 in region 304. An example of this configuration is illustrated in FIG. 4. Processes for monitoring network latency and engaging a proxy agent as needed in an environment such as that shown in FIG. 4 are discussed further below with reference to FIGS. 2-5.

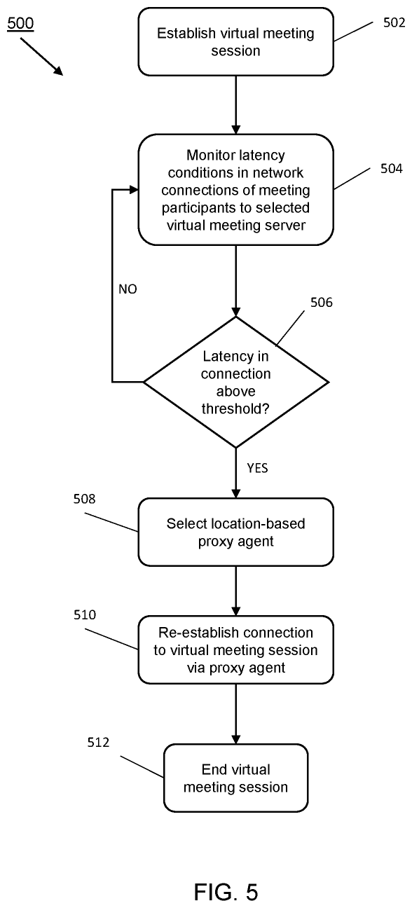

FIG. 5 illustrates a flow diagram of one example of method 500 of using a dynamically selected location-based proxy agent to improve virtual meeting performance in accord with aspects disclosed herein.

Referring to FIGS. 2-5, in step 502 a virtual meeting session can be established in a distributed workspace environment with multiple participants 302, 302a as discussed above. As part of step 502, a virtual meeting server 210 is selected, as also discussed above. According to certain embodiments, the digital workspace app 110 may monitor the network latency conditions in the network connections 308 (for each participant 302) and 310 (step 504). In certain examples, the digital workspace app 110 may monitor network latency information collected from the HDX engine 208. In other examples, the virtual meeting application 206 may collect network latency information which can be passed to the digital workspace app 110 (and/or the workspace backend 116). For example, the virtual meeting application may request information regarding the latency conditions from the virtual meeting server via the API 204. In further examples, the digital workspace app 110 may collect network latency information by sending out a test message (“ping”) and monitoring the return time of the test message.

If the latency in any given network connection (e.g., L₂ in network connection 310 for the purposes of illustration) is above a predetermined threshold, indicating that the associated participant (e.g., participant 302a) is likely experiencing poor meeting quality, the system revert to the use of a proxy agent 400 to enhance the audio and/or video performance (step 508). In certain examples, the digital workspace app 110 may provide a notification to the user associated with the participant 302a to direct the user to take action to select the proxy agent 400. In other examples, the system may automatically engage the proxy agent 400 without requiring the intervention of the user. The proxy agent 400 may be selected from a list of known available proxy agents, similar to selection of a TURN server (such as the virtual meeting server 210 in some examples) discussed above. In the scenario illustrated in FIG. 4, the selection of the proxy agent 400 may be based on the geographic location of the participant 302a as indicated by the internet protocol address of the device through which the participant 302a authenticated with the digital workspace. Once the proxy agent 400 has been identified, the HDX engine 208 may renegotiate the virtual meeting protocol through the proxy agent 400 and allow the participant 302a to rejoin the virtual meeting session (step 510).

The process ends with the end of the virtual meeting session (step 512).

With engagement of the proxy agent 400, a new network connection 402 is established between the virtual meeting server 210 and the proxy agent 400. Through appropriate selection of the proxy agent 400 and optionally through improved communications protocols between the virtual meeting server 210 and the proxy agent 400, this network connection 402 may have significantly improved network latency (L₃) conditions relative to the original network connection 310 between the participant 302a and the virtual meeting server 210. In addition, a new network connection 404 is established between the participant 302a and the proxy agent 400, similarly having improved latency conditions (L₄). The combined latency conditions of the network connections 402 and 404, which now establish the communications link between the participant 302a and the virtual meeting server 210 may thus be significantly improved relative to the latency conditions of the original network connection 310 (L₃+L₄<L₂). As a result, participant 302a may experience greatly improved audio and/or video performance during the virtual meeting session.

In certain examples, the improved latency conditions L₃ and L₄ are achieved because higher speed network connections 402, 404 are available between the proxy agent 400 and both the virtual meeting server 210 and the participant 302a. The use of the proxy agent 400 may be provided as an on-demand service managed through the virtual meeting application 206 and the virtualization environment 104 to offer faster network connections that are otherwise unavailable to the participant 302. As discussed above, when high latency (or optionally other poor network conditions) are detected on the original network connection 310, the proxy agent 400 can be engaged as needed to improve performance.

As shown in FIG. 4, engagement of the proxy agent 400 can be accomplished without disrupting the selection of the virtual meeting server 210 and/or the network connections 308 between participants 302 and the virtual meeting server 210. Thus, the meeting performance for the participants 302 still can be optimized using all the techniques discussed herein (including the use of HDX and RTC protocols) and optimal location-based selection of the virtual meeting server 210 based on region 304, while the meeting performance for the participant 302a can also be improved by adding the proxy agent 400 that can be selected based on the different location of the participant 302a.

According to certain embodiments, monitoring of the network latency conditions (step 504) can be performed at the time when each participant 302, 302a is joining the virtual meeting session. At that time, determination of whether or not a proxy agent 400 is needed for any one or more participants can be made, and the respective connection(s) re-established using the proxy agent(s) as needed. In certain examples, the latency monitoring of step 504 may continue to be performed periodically during the virtual meeting session, either continuously or at various intervals (e.g., every few seconds or every few minutes), and the proxy agent 400 may be engaged at any time during the virtual meeting session when high latency is detected on any participant's network connection to the virtual meeting server 210. Although the above discussion refers primarily to using the proxy agent 400 to address poor meeting performance for participant 302a in a distant geographic location 306 relative to the region 304 of the other participants 302, embodiments of the processes discussed herein are not limited to this scenario. The system may monitor the network latency conditions in any network connection corresponding to any participant 302, 302a and engage one or more proxy servers 400 as needed.

Thus, aspects and embodiments provide systems and methods in a distributed workspace environment for using the HDX engine 208 to automatically locate and engage a proxy agent 400 if a current network connection is too slow. In particular, as discussed above, aspects and embodiments provide for automatically monitoring latency in the network connections to a virtual meeting server 210 (such as a Microsoft TURN server in some examples), detecting high latency conditions in such a network connection, engaging a proxy agent 400, and dynamically re-establishing connection to the virtual meeting session via the HDX engine 208 at the endpoint device 102 and the proxy HDX engine at the proxy server 400. The systems and methods disclosed herein may advantageously improve HDX virtual meeting optimization quality.

Although discussed in the context of a virtual meeting session, those skilled in the art, given the benefit of this disclosure, may appreciate that the principles and aspects discussed herein may be applied to other applications in a distributed workspace system. For example, the digital workspace app 110 may monitor network connections between the virtual machine 118 and any of the application servers 108, and engage a proxy agent (similar to the manner discussed above) if high latency or poor performance is detected in any of the network connections. Thus, the digital workspace app 110 may provide proxy agent engagement as an “on-demand” service, either automatically or by allowing a user of the endpoint device 102 to select a proxy agent, as discussed above.

Sample Computing Platform

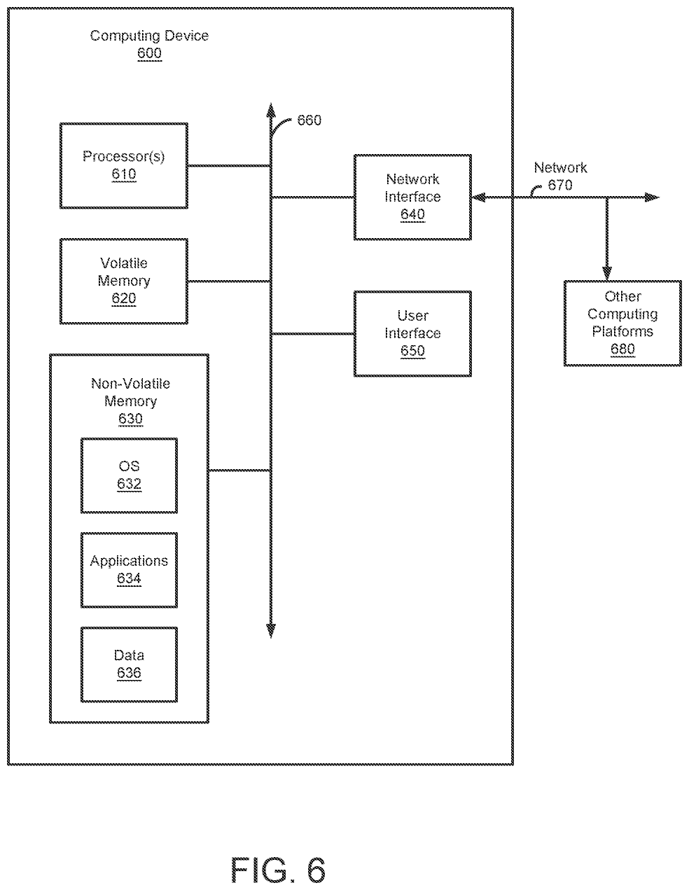

FIG. 6 is a block diagram of a computing platform 600 configured to implement various systems and processes in accordance with examples disclosed herein.

The endpoint device 102 and/or workspace server 104 are examples of computing systems that may be implemented using examples of the computing platform 600. The endpoint device 102 and the virtualization environment 104 can be implemented within any computing or processing environment with any type of physical or virtual machine or set of physical and virtual machines that can have suitable hardware and/or software capable of operating as described herein. In some examples, some components of the computing device can be implemented virtually (e.g., using a combination of hardware and software), such as to provide the virtual machine 118 to the digital workspace app 110 of the endpoint device 102, where the virtual machine 118 emulates certain processing functions of the endpoint computing system 102 using hardware components of the endpoint computing system 102 (e.g., processors, network communications hardware, I/O devices, etc.).

The computing platform 600 includes one or more processor(s) 610, volatile memory 620 (e.g., random access memory (RAM)), non-volatile memory 630, one or more network or communication interfaces 640, a user interface (UI) 650, and a communications bus 660. The computing platform 600 may also be referred to as a endpoint device, computer, computing device, server, or computer system.

The processor(s) 610 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals. In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory. The processor can be analog, digital, or mixed. In some examples, the processor can be one or more physical processors, which may be remotely located or local. A processor including multiple processor cores and/or multiple processors can provide functionality for parallel, simultaneous execution of instructions or for parallel, simultaneous execution of one instruction on more than one piece of data.

The non-volatile (non-transitory) memory 630 includes one or more machine-readable mediums that can include: one or more hard disk drives (HDDs) or other magnetic or optical machine-readable storage media; one or more machine-readable solid state drives (SSDs), such as a flash drive or other solid-state storage media; one or more hybrid machine-readable magnetic and solid-state drives; and/or one or more virtual machine-readable storage volumes, such as a cloud storage, or a combination of such physical storage volumes and virtual storage volumes or arrays thereof.

The non-volatile memory 630 stores an operating system (OS) 632, one or more applications or programs 634, and data 636. The OS 632 and the application(s) 634 include sequences of instructions that are encoded for execution by processor(s) 610. Execution of these instructions results in manipulated data. Prior to their execution, the instructions can be copied to the volatile memory 620. In some examples, the volatile memory 620 can include one or more types of RAM and/or a cache memory that can offer a faster response time than a main memory. Data can be entered through the user interface 650 or received from the other I/O device(s), such as the network interface 640. The various elements of the computing platform device 600 can communicate with one another via the communications bus 660.

The user interface 650 can include a graphical user interface (GUI) (e.g., controls presented on a touchscreen, a display, etc.) and one or more input/output (I/O) devices (e.g., a mouse, a keyboard, a microphone, one or more speakers, one or more cameras, one or more biometric scanners, one or more environmental sensors, and one or more accelerometers, one or more visors, etc.).

The network interface(s) 640 can include one or more interfaces to enable the computing platform 600 to access a computer network 670 (e.g., the network 106 discussed above) such as a Local Area Network (LAN), a Wide Area Network (WAN), a Personal Area Network (PAN), or the Internet through a variety of wired and/or wireless connections, including cellular connections. In some examples, the network 670 may allow for communication with other computing platforms 680 to enable distributed computing as discussed herein.

In various examples, the computing device 900 can execute an application on behalf of a user of a endpoint device. For example, the computing device 900 can execute one or more virtual machines managed by a hypervisor. Each virtual machine can provide an execution session within which applications execute on behalf of a user or an endpoint device 102, such as a hosted desktop session. The computing device 600 can also execute a terminal services session to provide a hosted desktop environment. The computing device 600 can provide access to a remote computing environment including one or more applications, one or more desktop applications, and one or more desktop sessions in which one or more applications can execute.

The illustrated computing platform 600 is shown merely as an example computing device and can be implemented by any computing or processing environment with any type of machine or set of machines that can have suitable hardware and/or software capable of operating as described herein.

### CONCLUSION

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings of various embodiments are presented by way of example only. These examples are not intended to be exhaustive or to limit the invention to the precise forms disclosed. The methods and apparatuses are capable of implementation in other embodiments and of being practiced or of being carried out in various ways.

For example, the processes disclosed herein depict one particular sequence of acts in a particular example. Some acts are optional and, as such, can be omitted in accord with one or more examples. Additionally, the order of acts can be altered, or other acts can be added, without departing from the scope of the apparatus and methods discussed herein.

In addition, the phraseology and terminology used herein is for the purpose of description and should not be regarded as limiting. Any references to examples, components, elements, or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including”, “comprising”, “having”, “containing”, “involving”, and variations thereof is meant to encompass the items listed thereafter and equivalents thereof as well as additional items. References to “or” can be construed as inclusive so that any terms described using “or” can indicate any of a single, more than one, and all of the described terms. The scope of the invention should be determined from proper construction of the appended claims, and their equivalents.

What is claimed is:

1. A method of improving performance in a virtual meeting session in a distributed workspace system, the method comprising:
launching the virtual meeting session via a virtual meeting application hosted by a virtual machine accessed through a digital workspace application executing on a computing device of a first meeting participant, the virtual meeting application being configured to admit the first meeting participant to the virtual meeting session;
establishing a first connection between the computing device and a virtual meeting server, wherein the virtual meeting server is a traversal using relay network address translation (TURN) server selected from a plurality of TURN servers based on a second geographic location of a second meeting participant in the virtual meeting session;
monitoring network latency conditions in the first network connection;
upon determining that the network latency conditions exceed a predetermined threshold, selecting a proxy agent based on a first geographic location of the computing device, the first and second geographic locations being different, and establishing a second network connection between the computing device and the proxy agent; and
establishing a third network connection between the virtual meeting server and the proxy agent to connect the computing device to the virtual meeting server through the proxy agent.

2. The method of claim 1, wherein monitoring latency conditions in the first network connection comprises requesting information regarding the latency conditions from the virtual meeting server via an application programming interface.

3. The method of claim 1, wherein monitoring latency conditions in the first network connection includes:
transmitting a test message from the computing device over the first network; and
monitoring a return time of the test message to the computing device.

4. (canceled)

5. The method of claim 1, wherein monitoring the network latency conditions is performed during the launching of the virtual meeting session on the computing device.

6. The method of claim 1, wherein monitoring the network latency conditions is performed periodically during the virtual meeting session.

7. (canceled)

8. A computer system comprising:
a memory storing a plurality of instructions;
at least one network interface; and
at least one processor coupled to the memory and to the at least one network interface and configured execute the plurality of instructions to:
launch a virtual meeting session using a virtual meeting application accessed through a digital workspace application executing on the computer system;
establish a first network connection to a virtual meeting server via the at least one network interface;
monitor latency conditions in the first network connection, wherein to monitor the latency conditions, the at least one processor is configured to request information regarding the latency conditions from the virtual meeting server via an application programming interface;
upon determination that the latency conditions exceed a predetermined threshold, select a proxy agent and establish a second network connection to the proxy agent; and
reestablish connection to the virtual meeting server via the proxy agent.

9. (canceled)

10. The computer system of claim 8, wherein to monitor the latency conditions, the at least one processor is further configured to:
transmit a test message over the first network; and
monitor a return time of the test message.

11. The computer system of claim 8, wherein the processor is configured to monitor the latency conditions during launch of the virtual meeting session.

12. The computer system of claim 8, wherein the processor is configured to monitor the latency conditions periodically during the virtual meeting session.

13. The computer system of claim 8, wherein the processor is configured to select the proxy agent based on a geographic location of the computer system.

14. A method of improving performance in a virtual meeting session in a distributed workspace system, the method comprising:
providing a digital workspace application on an endpoint computing device;
providing access through the digital workspace application, to a virtual meeting application;
launching the virtual meeting session using the virtual meeting application accessed through the digital workspace application;
establishing a first network connection from the computing device to a virtual meeting server, wherein the virtual meeting server is a traversal using relay network address translation (TURN) server selected from among a plurality of TURN servers based on a first geographic location of a first meeting participant in the virtual meeting session;
with the digital workspace application, monitoring network latency conditions in the first network connection;
upon determining that the network latency conditions exceed a predetermined threshold, selecting a proxy agent based on a second geographic location of the endpoint computing device, the first and second geographic locations being different, and establishing a second network connection from the computing device to the proxy agent; and
connecting to the virtual meeting server through the proxy agent to provide access to the virtual meeting session.

15. The method of claim 14, wherein monitoring latency conditions in the first network connection comprises requesting information regarding the latency conditions from the virtual meeting server via an application programming interface.

16. The method of claim 14, wherein monitoring latency conditions in the first network connection includes:
transmitting a test message from the computing device over the first network; and
monitoring a return time of the test message to the computing device.

17. (canceled)

18. The method of claim 14, wherein monitoring the network latency conditions is performed during the launching of the virtual meeting session using the virtual meeting application accessed through the digital workspace application.

19. The method of claim 14, wherein monitoring the network latency conditions is performed periodically during the virtual meeting session.

20. The method of claim 14, wherein selecting the proxy agent includes selecting the proxy agent to provide the second network connection having lower network latency conditions than the first network connection.
